(19) United States
(12) Patent Application Publication
(10) Pub. No.: US 2026/0037351 A1
(43) Pub. Date: Feb. 5, 2026

(54) System and Method for Classifying, Summarizing and Identifying Data Using Artificial Intelligence

(71) Applicant: RelevAInce, LLC, Dallas, TX (US)

(72) Inventors: Steve Henry, Dallas, TX (US); Victor Nilson, Frisco, TX (US)

(21) Appl. No.: 19/285,527

(22) Filed: Jul. 30, 2025

Related U.S. Application Data
(60) Provisional application No. 63/677,032, filed on Jul. 30, 2024.

(51) Int. Cl. G06F 9/54; G06F 16/953

(52) U.S. Cl. CPC G06F 9/547; G06F 16/953

(57) ABSTRACT

A system and method includes: providing a system comprising one or more servers, a user interface communicably coupled to the one or more servers, one or more databases communicably coupled to the one or more servers, and one or more large language models communicably coupled to the one or more servers; automatically classifying one or more files or objects within the one or more databases based on one or more identifiers using the one or more servers; automatically summarizing the one or more files or objects using an autonomous AI agent on the one or more servers and communicably coupled to the one or more databases and the one or more large language models; automatically identifying people, organizations and issues within the one or more files or objects using the autonomous AI agent; and storing the summaries, and identified people, organizations and issues within the one or more databases.

### CROSS-REFERENCE TO RELATED APPLICATIONS

This patent application claims priority to U.S. Provisional Patent Application No. 63/677,032 filed on Jul. 30, 2024, the contents of which are hereby incorporated by reference in their entirety.

### TECHNICAL FIELD OF THE INVENTION

The present invention relates in general to the field of artificial intelligence, and more particularly, to a system and method for classifying, summarizing and identifying data using artificial intelligence.

### STATEMENT OF FEDERALLY FUNDED RESEARCH

Not applicable.

### BACKGROUND OF THE INVENTION

Without limiting the scope of the disclosure, its background is described in connection with computer systems for various industries, such as: legal, risk management, medical, insurance, construction and more. While the present disclosure can apply to these industries, the background will be described with respect to the legal industry for illustration purposes only.

Traditional legal case development/management and trial preparation processes are time-consuming, labor-intensive, expensive and prone to human error. The increasing volume of digital evidence and the complexity of modern legal cases further exacerbate these challenges. There is a pressing need for innovative solutions that can streamline these processes, enhance the accuracy of legal analysis, reduce the costs associated with eDiscovery and legal fees, and support, enhance and expedite effective decision-making by legal professionals.

Traditional risk management processes are equally time-consuming, labor intensive, expensive and prone to many risks being unidentified, insufficiently identified or untimely identified. As such, by the time a risk manager may be aware of the risk it is too late to implement sufficient risk management efforts. There is also a pressing need for innovative solutions to expedite and enhance risk identification and risk notification to risk decision makers so that proper risk management efforts can be implemented and reduce the potential harm to the business and overall economy.

In any legal sphere or business meeting where verbal communications are conducted (e.g., deposition, arbitration, trial testimony, business meeting, etc.), a complete and real-time understanding of all relevant facts and issues, whether from prior statements, testimony, emails, documentation, the internet or otherwise, is necessary for a participant's success in such meeting. For example, if you had a paralegal or assistant with perfect knowledge and perfect recall of all relevant facts listening to a communication and whispering in your ear, you would be better positioned to identify any facts that either contradict or support any communication and, as such, more effectively bolster your position.

Accordingly, there is a need for a system and method for classifying, summarizing and identifying data using artificial intelligence.

### SUMMARY OF THE INVENTION

This disclosure provides an artificial intelligence (AI) powered system that automates data collection, classification and analysis, and provides real-time interactive querying and analysis with generative AI using specialized AI agents. The system can be used in many different applications, such as legal, risk management, medical, insurance, construction and more.

In one embodiment of the present disclosure, a system includes: an application server having one or more first application programming interfaces (APIs); a user interface communicably coupled to the application server with one of the first APIs; an automation server having one or more second APIs; an online transaction processing database communicably coupled to the application server with one of the first APIs, and the automation server with one of the second APIs; one or more large language models (LLMs) communicably coupled to the application server with one of the first APIs, and the automation server with one of the second APIs; a vector database communicably coupled to the application server with one of the first APIs, and the automation server with one of the second APIs; a file or object storage platform communicably coupled to the application server with one of the first APIs, and the automation server with one of the second APIs; and a graph database communicably coupled to the application server with one of the first APIs, and the automation server with one of the second APIs.

In one aspect, the one or more first APIs include a category-based API, a LLM chat API, a file cabinet API, a notes management API, a user management API, or an audit and logging API. In another aspect, the second APIs include: a continuous integrations and continuous delivery API, a workflow management API, a scheduler and batch processing API, an orchestration API, an automation API, and a data pipeline API. In another aspect, the user interface includes a web interface, a mobile interface, or a desktop interface. In another aspect, the system further includes a microphone communicably coupled to the application server with one of the first APIs or the user interface, a camera communicably coupled to the application server with one of the first APIs or the user interface, or a document scanner communicably coupled to the application server with one of the first APIs or the user interface. In another aspect, the one or more LLMs are internally hosted or externally secure. In another aspect, files or objects within the file or object storage platform are automatically formatted. In another aspect, files or objects within the file or object storage platform are automatically summarized by embedding the files or objects into chunks in the vector database, clustering the chunks using ranked similarity scores or a K-means for K clusters, extracting M chunks of text for each of the K clusters, and summarizing the M chunks with one of the LLMs into summaries for the files or objects. In another aspect, the LLM learns and optimizes the embedding, clustering, extracting and summarizing steps over time. In another aspect, files or objects within the file or object storage platform are automatically classified using one or more identifiers. In another aspect, the one or more identifiers include a file or object type, a legal classification, a person related to or mentioned in the file or object, an entity related to or mentioned in the file or object, or an issue related or mentioned in the file or object. In another aspect, a graph analysis is performed on the files or objects within the file or object storage platform.

In another aspect, the system further includes an AI generative document creator communicably coupled to the application server. In another aspect, the system further includes one or more autonomous AI agents communicably coupled to the one or more LLMs. In another aspect, each autonomous AI agent has a configuration including a backstory, one or more goals, a model selected from the one or more LLMs, one or more training tools, and a required output. In another aspect, the required output includes one or more citations to a supporting file or object. In another aspect, a summary of the supporting file or object, an identification of people, organizations and issues within the supporting file or object, and a full text of the supporting file or object with one or more highlighted portions relied upon by the autonomous AI agent are provided. In another aspect, the one or more training tools include files or objects within all or part of the file or object storage platform, specified files or objects, a chat interface, one or more retrieval-augmented generation tools, one or more knowledge graphs, a web searching tool, or other autonomous AI agents. In another aspect, each chat via the chat interface is automatically dated and stored in a chat history. In another aspect, the chat history is searchable or accessible by other autonomous AI agents or the user interface. In another aspect, the one or more autonomous AI agents include a project manager AI agent, a lawyer drafting AI agent, a research assistant AI agent, a legal analyst AI agent, a real-time monitoring AI agent, a jury selection AI agent, a data scoring AI agent, a prosecution/plaintiff lawyer AI agent, a defense lawyer AI agent, a judge AI agent, a case development AI agent, a deposition, trial or appeal simulation AI agent, a mock trial game theory AI agent for strategy development and training purposes, an AI agent representing any other member or expert of any aspect of a case, a dynamically added AI agent, or a risk assessment AI agent. In another aspect, the one or more autonomous AI agents include a risk assessment AI agent, and the risk assessment AI agent monitors electronic communications and data across one or more projects and locations, determines a risk level of each project and location based on the monitored electronic communications and data, and reports the risk level using the user interface. In another aspect, the risk assessment AI agent provides a notification of any change in the risk level using the user interface, and identifies any documentation or information relied upon to make the change in risk level. In another aspect, the risk assessment AI agent generates one or more risk mitigation strategies in response to the change in risk level.

In another aspect, the one or more autonomous AI agents are configured to operate a workflow stage including information gathering, claim evaluation, formal legal proceedings, formal case inventory initiation, formal discovery, case evaluation, depositions, hearings, trial preparation, trial, or appeal. In another aspect, the one or more autonomous AI agents include a generative AI document creator that is configured to generate a draft outline of inquiry to be used in a deposition or a trial witness examination, an initial draft of interrogatories, requests for production or requests for admissions, an initial draft of a motion or other pleading to be filed with a court, an initial draft of materials used as a foundation for further legal research, or an initial draft of a contract, agreement or other legal document. In another aspect, the one or more autonomous AI agents include a real-time monitoring AI agent and the system further includes a microphone is communicably coupled to the real-time monitoring AI agent, a camera is communicably coupled to the real-time monitoring AI agent, and wherein the real-time monitoring AI agent is configured to receive audio data of one or more people from the microphone, receive video data of the one or more people from the camera, identify the one or more people based on the audio data, the video data, or a combination of the audio data and the video data, identify a statement within the audio data or the video data, and provide the statement to a user using the user interface. In another aspect, the real-time monitoring AI agent is further configured to access data relevant to the statement within the vector database, the file or object storage platform or the graph database, and wherein the statement includes an inconsistency or falsehood based on the accessed data or behavioral clues from the one or more people within the audio data or the video data, and the data accessed from the one or more databases. In another aspect, the statement includes a sentiment of the one or more people based on behavioral clues within the audio data or the video data. In another aspect, the real-time monitoring AI agent is further configured to access data relevant to the statement within the vector database, the file or object storage platform or the graph database, and wherein the statement includes a relevant law, case or argument based on the audio data or the video data and the data accessed from the one or more databases.

In another embodiment of the present disclosure, a method includes: providing a system including one or more servers, a user interface communicably coupled to the one or more servers, one or more databases communicably coupled to the one or more servers, and one or more large language models (LLMs) communicably coupled to the one or more servers; automatically classifying one or more files or objects within the one or more databases based on one or more identifiers using the one or more servers; automatically summarizing the one or more files or objects using a first autonomous AI agent on the one or more servers and communicably coupled to the one or more databases and the one or more LLMs; automatically identifying people, organizations and issues within the one or more files or objects using a second autonomous AI agent; and storing the summaries, and identified people, organizations and issues within the one or more databases.

In one aspect, automatically summarizing the one or more files or objects using the first autonomous AI agent includes embedding the files or objects into chunks in a vector database, clustering the chunks using ranked similarity scores or a K-means for K clusters, extracting M chunks of text for each of the K clusters, and summarizing the M chunks with one of the LLMs into summaries for the files or objects. In another aspect, the LLMs learns and optimizes the embedding, clustering, extracting and summarizing steps over time. In another aspect, the method further includes automatically providing a full text of the files or objects with one or more highlighted portions relied upon by the second autonomous AI agent. In another aspect, the method further includes configuring the first or second autonomous AI agent with a backstory, one or more goals, a model selected from the one or more LLMs, one or more training tools, and a required output. In another aspect, the required output includes one or more citations to a supporting file or object. In another aspect, the method further includes providing a summary of the supporting file or object, an identification of people, organizations and issues within the supporting file or object, and a full text of the supporting file or object with one or more highlighted portions relied upon by the first or second autonomous AI agent. In another aspect, the one or more training tools include files or objects within all or part of the one or more databases, specified files or objects, a chat interface, one or more retrieval-augmented generation tools, one or more knowledge graphs, a web searching tool, or other autonomous AI agents. In another aspect, the method further includes automatically formatting files or objects within the one or more databases using the one or more servers.

In another aspect, the method further includes automatically generating one or more documents using an AI generative document creator on the one or more servers. In another aspect, the one or more documents include a draft outline of inquiry to be used in a deposition or a trial witness examination, an initial draft of interrogatories, requests for production or requests for admissions, an initial draft of a motion or other pleading to be filed with a court, an initial draft of materials used as a foundation for further legal research, or an initial draft of a contract, agreement or other legal document. In another aspect, the method further includes providing a risk assessment AI agent on the one or more servers with access to electronic communications and data across one or more projects and locations, monitoring the electronic communications and data using the risk assessment AI agent, determining a risk level of each project and location based on the monitored electronic communications and data by the risk assessment AI agent, and reporting the risk level to a user using the user interface. In another aspect, the method further includes providing a notification of any change in the risk level using the user interface, and identifying any documentation or information relied upon to make the change in risk level by the risk assessment AI agent. In another aspect, the method further includes generating one or more risk mitigation strategies in response to the change in risk level by the risk assessment AI agent. In another aspect, the one or more identifiers include a file or object type, a legal classification, a person related to or mentioned in the file or object, an entity related to or mentioned in the file or object, or an issue related or mentioned in the file or object. In another aspect, the method further includes performing a graph analysis on the one or more files or objects. In another aspect, the method further includes storing the graph analysis in a graph database communicably coupled to the one or more servers. In another aspect, the method further includes providing a real-time monitoring AI agent on the one or more servers and communicably coupled to a microphone and a camera, receiving audio data of one or more people from the microphone, receiving video data of the one or more people from the camera, identifying the one or more people by the real-time monitoring AI agent based on the audio data, the video data, or a combination of the audio data and the video data, identifying a statement within the audio data or the video data by the real-time monitoring AI agent, and providing the statement to a user using the user interface. In another aspect, the method further includes accessing data relevant to the statement within the one or more databases, and wherein the statement includes an inconsistency or falsehood based on the accessed data or behavioral clues from the one or more people within the audio data or the video data, and the data accessed from the one or more databases. In another aspect, the statement includes a sentiment of the one or more people based on behavioral clues within the audio data or the video data. In another aspect, the method further includes accessing data relevant to the statement within the one or more databases, and wherein the statement includes a new information from the one or more people based on the audio data or the video data and the data accessed from the one or more databases. In another aspect, the method further includes accessing data relevant to the statement within the one or more databases, and wherein the statement includes a relevant law, case or argument based on the audio data or the video data and the data accessed from the one or more databases. In another aspect, the method further includes automatically dating and storing a chat with the one or more LLMs in a chat history. In another aspect, the chat history is searchable or accessible by a third autonomous AI agent.

In another aspect, the method further includes a fourth autonomous AI agent including a project manager AI agent, a lawyer drafting AI agent, a research assistant AI agent, a legal analyst AI agent, a real-time monitoring AI agent, a jury selection AI agent, a data scoring AI agent, a prosecution/plaintiff lawyer AI agent, a defense lawyer AI agent, a judge AI agent, a case development AI agent, a deposition, trial or appeal simulation AI agent, a mock trial game theory AI agent for strategy development and training purposes, an AI agent representing any other member or expert of any aspect of a case, a dynamically added AI agent, or a risk assessment AI agent. In another aspect, the method further includes configuring the fourth autonomous AI agent to operate a workflow stage including information gathering, claim evaluation, formal legal proceedings, formal case inventory initiation, formal discovery, case evaluation, depositions, hearings, trial preparation, trial, or appeal. In another aspect, the one or more servers include an application server having one or more first application programming interfaces (APIs), and an automation server having one or more second APIs. In another aspect, the first APIs include a category-based API, a LLM chat API, a file cabinet API, a notes management API, a user management API, or an audit and logging API. In another aspect, the second APIs include a continuous integrations and continuous delivery API, a workflow management API, a scheduler and batch processing API, an orchestration API, an automation API, or a data pipeline API. In another aspect, the one or more databases include an online transaction processing database communicably coupled to the one or more servers, a vector database communicably coupled to the one or more servers, a file or object storage platform communicably coupled to the one or more servers, and a graph database communicably coupled to the one or more servers. In another aspect, the user interface includes a web interface, a mobile interface, or a desktop interface. In another aspect, the method further includes providing a microphone communicably coupled to the one or more servers or the user interface, a camera communicably coupled to the one or more servers or the user interface, or a document scanner communicably coupled to the one or more servers or the user interface. In another aspect, the one or more LLMs are internally hosted or externally secure.

Note that the invention is not limited to the embodiments described herein, instead it has the applicability beyond the embodiments described herein. The brief and detailed descriptions of this disclosure are given in the following.

### BRIEF DESCRIPTION OF THE DRAWINGS

For a more complete understanding of the features and advantages of the present invention, reference is now made to the detailed description of the invention along with the accompanying figures and in which:

FIG. 1 depicts a block diagram of a high level architecture of a system in accordance with one embodiment of the present disclosure;

FIG. 2 depicts a block diagram of a high level architecture of a system in accordance with another embodiment of the present disclosure;

FIG. 3 depicts a flow chart of a method in accordance with another embodiment of the present disclosure;

FIG. 3 depicts a data processing flowchart of a method in accordance with one embodiment of the present disclosure;

FIG. 4 depicts an example of a document (email) that is jumbled in its native format in accordance with one embodiment of the present disclosure;

FIG. 5 depicts the document (email) of FIG. 4 after it has been automatically formatted in accordance with one embodiment of the present disclosure; and

FIG. 6 depicts a block diagram of a risk management AI agent in accordance with one embodiment of the present disclosure.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity but include the general class of which a specific example may be used for illustration. The terminology herein is used to describe specific embodiments of the invention, but their usage does not limit the invention, except as outlined in the claims.

Various methods are described below to provide an example of each claimed embodiment. They do not limit any claimed embodiment. Any claimed embodiment may cover methods that are different from those described above and below. The drawings and descriptions are for illustrative, rather than restrictive, purposes.

This disclosure provides an artificial intelligence (AI) powered system that automates data collection, classification and analysis, and provides real-time interactive querying and analysis with generative AI using specialized AI agents. The system can be used in many different applications, such as legal, risk management, medical, insurance, construction and more.

For example, company data, including but not limited to contracts, emails, architectural plans, sales projections, purchasing and account information, is monitored in real time by AI agents that are programmed to quickly identify, monitor, and assess ongoing risk. Upon analyzing and identifying such potential risk, the AI agents categorize the risk into levels of low, medium, and high so that each may be reported to senior management or legal to be addressed accordingly. Other scoring methods can be use. These AI agents may be customized and programmed to work in a hospital, insurance, construction, or any other industry in which review of a voluminous data set to assess daily or future risk and identify potential mitigation efforts affects the industry. The programmed AI agent(s) have the ability to ingest the dataset quickly, learn the information, recall the information it has already input, and assess the situation and risk and report almost instantaneously.

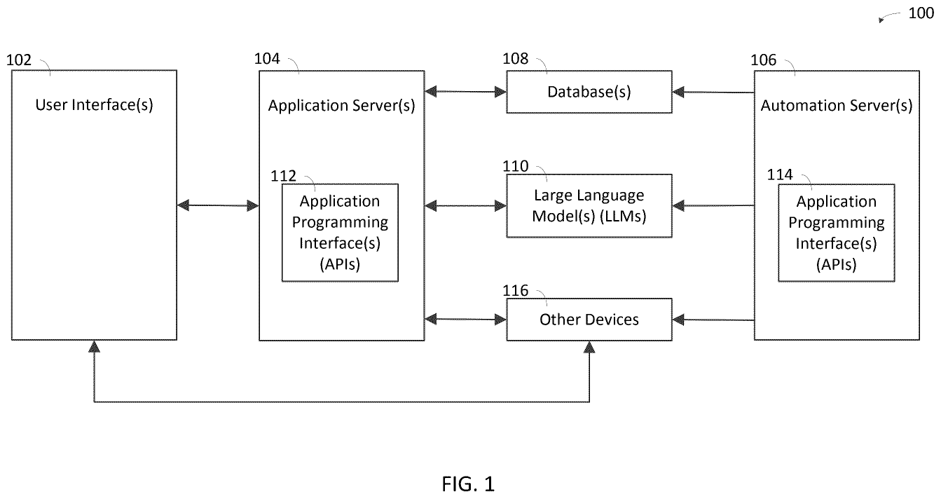

Now referring to FIG. 1, a block diagram of a high level architecture of a system 100 in accordance with one embodiment of the present disclosure is shown. The system 100 includes one or more user interfaces 102, an application server 104, an automation server 106, one or more databases 108, and one or more large language models (LLMs) 110. In some embodiments, the LLMs can be of various sizes, and are specifically trained to “memorize” all data and documents of a given case, project or specified area of interest, so that any question can simple be asked directly of the LLM itself (versus retrieving relevant portions of documents related to a question). The application server 104 includes multiple application programming interfaces (APIs) 112 (also referred to as first APIs) that are used to interface with the one or more user interfaces 102, the one or more databases 108, and the one or more LLMs 110. Similarly, the automation server 106 includes multiple APIs 114 (also referred to as second APIs) that are used to interface with the one or more databases 108 and the one or more LLMs 110. In addition, the application server 104, the automation server 106, their respective APIs 112 and 114, one or more database 108 and/or one or more LLMs 110 can be communicably coupled to one or more other devices 116. The number and type of the one or more databases 108 will depend on the application and data for which the system 100 is used. The LLMs 110 can be custom built LLMs or third-party LLMs. In addition, multiple LLMs 110 can be used to leverage different training methods to achieve better results. The one or more user interfaces 102 authorize and authenticate users/devices and provide secure access to the application server 104 and its APIs 112. The one or more user interfaces 102 may include separate interfaces for web-based access, mobile application access, desktop access, etc. The APIs 112 and 114, one or more databases 108 and one or more LLMs 110 are configured to customize the system 100 to specific application(s) and/or operating environments. Note that all the components in the system 100 can be local, remote, cloud-based, or any combination thereof, and can be directly or indirectly communicably coupled with one another via direct, wired or wireless communication methods.

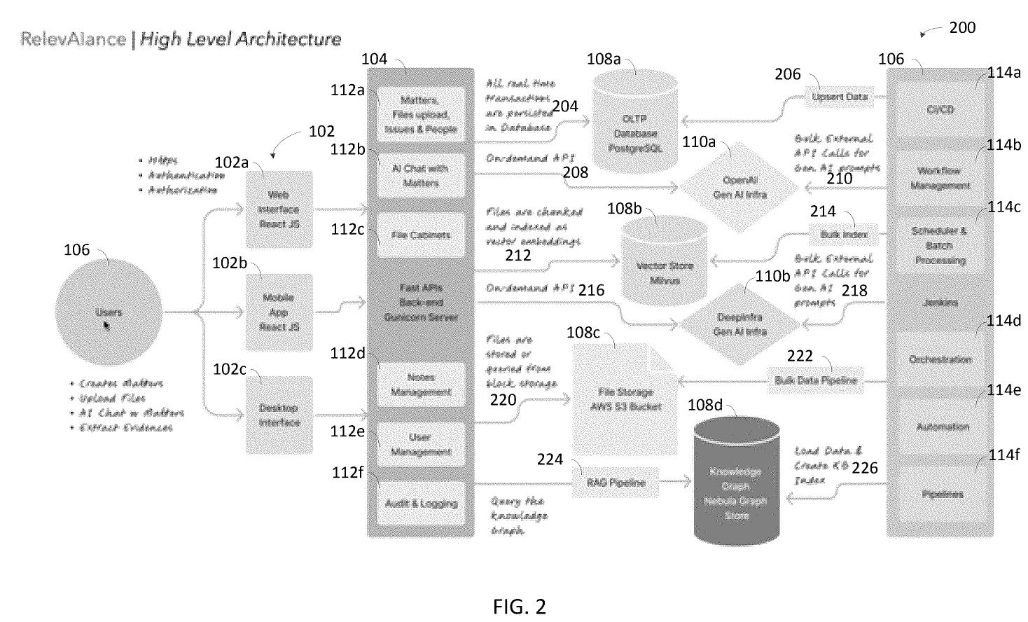

Referring now to FIG. 2, a block diagram of a high level architecture of a system 200 in accordance with another embodiment of the present disclosure is shown. An application server 104, such as a back-end Gunicorn server, has one or more first APIs 112 (e.g., 112a, 112b, 112c, 112d, 112e, 112f, etc.). The application server 104 can be a single server or multiple servers. A user interface 102 (e.g., 102a, 102b, 102c, etc.) is communicably coupled to the application server 104 with one of the first APIs 112. An automation server 106, such as a Jenkins server, has one or more second APIs 114 (e.g., 114a, 114b, 114c, 114d, 114c, 114f, etc.). The automation server 106 can be a single server or multiple servers. One or more databases 108 include an online transaction processing database 108a, a vector database 108b, a file or object storage platform 108c, and a graph database 108d. The online transaction processing database 108a is communicably coupled to the application server 104 with one of the first APIs 112, and the automation server 106 with one of the second APIs 114. The vector database 108b is communicably coupled to the application server 104 with one of the first APIs 112, and the automation server 106 with one of the second APIs 114. The file or object storage platform 108c is communicably coupled to the application server 104 with one of the first APIs 112, and the automation server 106 with one of the second APIs 114. The graph database 108d is communicably coupled to the application server 104 with one of the first APIs 112, and the automation server 106 with one of the second APIs 114. One or more LLMs 110, such as Open AI generative AI infrastructure 110a or Deepinfra generative AI infrastructure 110b, or locally hosted infrastructure are communicably coupled to the application server 104 with one of the first APIs 112, and the automation server 106 with one of the second APIs 114. In some embodiments, the LLMs 110 can be of various sizes, and are specifically trained to “memorize” all data and documents of a given case, project or specified area of interest, so that any question can simple be asked directly of the LLM itself (versus retrieving relevant portions of documents related to a question). Other types of language models of various sizes or specifically trained models can be used.

Users 202 access the system 200 using the user interface 102, which may include a web interface 102a, a mobile interface 102b, or a desktop interface 102c. Among other things, the users 202 can create matters, upload files, AI chat with matters and extract evidence. The user interface(s) 102 provide secure communications with the application server 104 and authenticate and authorize users and/or devices. More or less user interfaces including other user interfaces can be used. The first APIs 112 may include a category-based API 112a (e.g., matters, files upload, issues, people, etc.), a LLM chat API 112b, a file cabinet API 112c, a notes management API 112d, a user management API 112e, or an audit and logging API 112f. More or less first APIs including other first APIs can be used. The second APIs may include a continuous integrations and continuous delivery (CI/CD) API 114a, a workflow management API 114b, a scheduler and batch processing API 114c, an orchestration API 114d, an automation API 114c, and a data pipeline API 114f. More or less second APIs including other second APIs can be used.

All real time transactions 204 from the application server 104 are persisted in the online transaction processing database 108a. In addition, upsert data 206 is persisted in the online transaction processing database 108a from the automation server 106. An on-demand API 208 provides an interface between the application server 104 and the LLMs hosted by Open AI generative AI infrastructure 110a or otherwise. Bulk external API calls for generative AI prompts 210 are provided to the Open AI generative AI infrastructure 110a from the automation server 106. Files are chunked and indexed as vector embeddings 212 into a vector database 108b and/or a graph database 108d from the application server 104. Bulk indexes 214 are provided to the vector database 108b and/or graph database 108d from the automation server 106. An on-demand API 216 provides an interface between the application server 104 and the generative AI infrastructure 110b (here shown as cloud vendor deepinfra.com). Bulk external API calls for generative AI prompts 218 are provided to the generative AI infrastructure 110b from the automation server 106. Files are stored or queried 220 from a file or object storage platform 108c, such as an AWS S3 Bucket. In addition, a bulk data pipeline 222 is provided between the file or object storage platform 108c and the automation server 106. The application server 104 can query a knowledge graph stored in the graph database 108d using a retrieval augmented generation (RAG) pipeline 224. The automation server 106 loads data and creates KB index 226 in the graph database 108d.

In one aspect, a microphone is communicably coupled to the application server with one of the first APIs or the user interface, a camera is communicably coupled to the application server with one of the first APIs or the user interface, or a document scanner is communicably coupled to the application server with one of the first APIs or the user interface. In another aspect, the one or more LLMs are internally hosted or externally secure. In another aspect, files or objects within the file or object storage platform are automatically formatted. In another aspect, files or objects within the file or object storage platform are automatically summarized by embedding the files or objects into chunks in the vector database, clustering the chunks using ranked similarity scores or a K-means for K clusters, extracting M chunks of text for each of the K clusters, and summarizing the M chunks with one of the LLMs into summaries for the files or objects. In another aspect, the LLM learns and optimizes the embedding, clustering, extracting and summarizing steps over time. In another aspect, files or objects within the file or object storage platform are automatically classified using one or more identifiers. In another aspect, the one or more identifiers include a file or object type, a legal classification, a person related to or mentioned in the file or object, an entity related to or mentioned in the file or object, or an issue related or mentioned in the file or object. In another aspect, a graph analysis is performed on the files or objects within the file or object storage platform.

In another aspect, an AI generative document creator is communicably coupled to the application server. In another aspect, one or more autonomous AI agents are communicably coupled to the one or more LLMs. In another aspect, each autonomous AI agent has a configuration that includes a backstory, one or more goals, a model selected from the one or more LLMs, one or more training tools, and a required output. In another aspect, the required output includes one or more citations to a supporting file or object. In another aspect, a summary of the supporting file or object, an identification of people, organizations and issues within the supporting file or object, and a full text of the supporting file or object with one or more highlighted portions relied upon by the autonomous AI agent are provided. In another aspect, the one or more training tools include files or objects within all or part of the file or object storage platform, specified files or objects, a chat interface, one or more retrieval-augmented generation tools, one or more knowledge graphs, a web searching tool, or other autonomous AI agents. In another aspect, each chat via the chat interface is automatically dated and stored in a chat history. In another aspect, the chat history is searchable or accessible by other autonomous AI agents or the user interface. In another aspect, the one or more autonomous AI agents include a project manager AI agent, a lawyer drafting AI agent, a research assistant AI agent, a legal analyst AI agent, a real-time monitoring AI agent, a jury selection AI agent, a data scoring AI agent, a prosecution/plaintiff lawyer AI agent, a defense lawyer AI agent, a judge AI agent, a case development AI agent, a deposition, trial or appeal simulation AI agent, a dynamically added AI agent, a game theory AI agent for strategy development and training purposes, an AI agent representing any other member or expert of any aspect of a case, or a risk assessment AI agent. In another aspect, the one or more autonomous AI agents include a risk assessment AI agent, and the risk assessment AI agent monitors electronic communications and data across one or more projects and locations, determines a risk level of each project and location based on the monitored electronic communications and data, and reports the risk level using the user interface. In another aspect, the risk assessment AI agent provides a notification of any change in the risk level using the user interface, and identifies any documentation or information relied upon to make the change in risk level. In another aspect, the risk assessment AI agent generates one or more risk mitigation strategies in response to the change in risk level.

In another aspect, the one or more autonomous AI agents are configured to operate a workflow stage that includes information gathering, claim evaluation, formal legal proceedings, formal case inventory initiation, formal discovery, case evaluation, depositions, hearings, trial preparation, trial, or appeal. In another aspect, the one or more autonomous AI agents include a generative AI document creator that is configured to generate a draft outline of inquiry to be used in a deposition or a trial witness examination, an initial draft of interrogatories, requests for production or requests for admissions, an initial draft of a motion or other pleading to be filed with a court, an initial draft of materials used as a foundation for further legal research, or an initial draft of a contract, agreement or other legal document. In another aspect, the one or more autonomous AI agents includes a real-time monitoring AI agent and further including, a microphone is communicably coupled to the real-time monitoring AI agent, a camera is communicably coupled to the real-time monitoring AI agent, wherein the real-time monitoring AI agent is configured to receive audio data of one or more people from the microphone, receive video data of the one or more people from the camera, identify the one or more people based on the audio data, the video data, or a combination of the audio data and the video data, identify a statement within the audio data or the video data, and provide the statement to a user using the user interface. In another aspect, the real-time monitoring AI agent is further configured to access similar data (portions of documents) relevant to the statement within the vector database, the file or object storage platform or the graph database, and wherein the statement includes an inconsistency or falsehood based on the accessed data or behavioral clues from the one or more people within the audio data or the video data, and the data accessed from the one or more databases. In another aspect, the statement includes a sentiment of the one or more people based on behavioral clues within the audio data or the video data. In another aspect, the real-time monitoring AI agent is further configured to access data relevant to the statement within the vector database, the file or object storage platform or the graph database, and wherein the statement includes a relevant law, case or argument based on the audio data or the video data and the data accessed from the one or more databases.

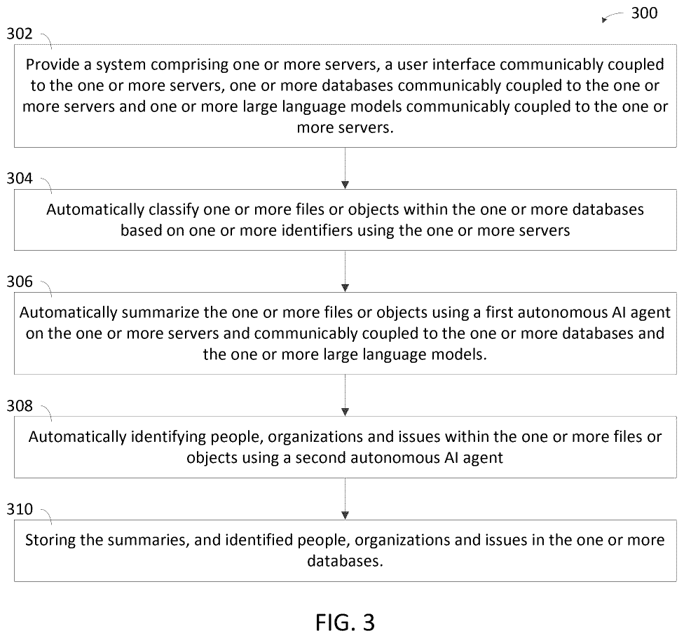

Now referring to FIG. 3, a flow chart of a method 300 in accordance with another embodiment of the present disclosure is shown. A system is provided in block 302 that includes one or more servers, a user interface communicably coupled to the one or more servers, one or more databases communicably coupled to the one or more servers, and one or more LLMs communicably coupled to the one or more servers. (see e.g., FIG. 1). In some embodiments, the LLMs can be of various sizes, and are specifically trained to “memorize” all data and documents of a given case, project or specified area of interest, so that any question can simple be asked directly of the LLM itself (versus retrieving relevant portions of documents related to a question). One or more files or objects within the one or more databases are automatically classifying based on one or more identifiers using the one or more servers in block 304. The one or more files or objects are automatically summarized using a first autonomous AI agent on the one or more servers and communicably coupled to the one or more databases and the one or more LLMs in block 306. People, organizations and issues within the one or more files or objects are automatically identified using a second autonomous AI agent in block 308. The summaries, and identified people, organizations and issues are stored within the one or more databases in block 310.

In one aspect, automatically summarizing the one or more files or objects using the autonomous first AI agent includes embedding the files or objects into chunks in a vector database, clustering the chunks using ranked similarity scores or a K-means for K clusters, extracting M chunks of text for each of the K clusters, and summarizing the M chunks with one of the LLMs into summaries for the files or objects. In another aspect, the one or more LLMs learn and optimize the embedding, clustering, extracting and summarizing steps over time. In another aspect, the method further includes automatically providing a full text of the files or objects with one or more highlighted portions relied upon by the second autonomous AI agent. In another aspect, the method further includes configuring the first or second autonomous AI agent with a backstory, one or more goals, a model selected from the one or more LLMs, one or more training tools, and a required output. In another aspect, the required output includes one or more citations to a supporting file or object. In another aspect, the method further includes providing a summary of the supporting file or object, an identification of people, organizations and issues within the supporting file or object, and a full text of the supporting file or object with one or more highlighted portions relied upon by the first or second autonomous AI agent. In another aspect, the one or more training tools include files or objects within all or part of the one or more databases, specified files or objects, a chat interface, one or more retrieval-augmented generation data pipelines, one or more knowledge graphs, a web searching tool, or other autonomous AI agents. In another aspect, the method further includes automatically formatting files or objects within the one or more databases using the one or more servers. In another aspect, the method further includes automatically generating one or more documents using an AI generative document creator on the one or more servers. In another aspect, the one or more documents include a draft outline of inquiry to be used in a deposition or a trial witness examination, an initial draft of interrogatories, requests for production or requests for admissions, an initial draft of a motion or other pleading to be filed with a court, an initial draft of materials used as a foundation for further legal research, or an initial draft of a contract, agreement or other legal document.

In another aspect, the method further includes providing a risk assessment AI agent on the one or more servers with access to electronic communications and data across one or more projects and locations, monitoring the electronic communications and data using the risk assessment AI agent, determining a risk level of each project and location based on the monitored electronic communications and data by the risk assessment AI agent, and reporting the risk level to a user using the user interface. In another aspect, the method further includes providing a notification of any change in the risk level using the user interface, and identifying any documentation or information relied upon to make the change in risk level by the risk assessment AI agent. In another aspect, the method further includes generating one or more risk mitigation strategies in response to the change in risk level by the risk assessment AI agent. In another aspect, the one or more identifiers include a file or object type, a legal classification, a person related to or mentioned in the file or object, an entity related to or mentioned in the file or object, or an issue related or mentioned in the file or object. In another aspect, the method further includes performing a graph analysis on the one or more files or objects. In another aspect, the method further includes storing the graph analysis in a graph database communicably coupled to the one or more servers.

In another aspect, the method further includes providing a real-time monitoring AI agent on the one or more servers and communicably coupled to a microphone and a camera, receiving audio data of one or more people from the microphone, receiving video data of the one or more people from the camera, identifying the one or more people by the real-time monitoring AI agent based on the audio data, the video data, or a combination of the audio data and the video data, identifying a statement within the audio data or the video data by the real-time monitoring AI agent, and providing the statement to a user using the user interface. In another aspect, the method further includes accessing data relevant to the statement within the one or more databases, and wherein the statement includes an inconsistency or falsehood based on the accessed data or behavioral clues from the one or more people within the audio data or the video data, and the data accessed from the one or more databases. In another aspect, the statement includes a sentiment of the one or more people based on behavioral clues within the audio data or the video data. In another aspect, the method further includes accessing data relevant to the statement within the one or more databases, and wherein the statement includes a new information from the one or more people based on the audio data or the video data and the data accessed from the one or more databases. In another aspect, the method further includes accessing data relevant to the statement within the one or more databases, and wherein the statement includes a relevant law, case or argument based on the audio data or the video data and the data accessed from the one or more databases. In another aspect, the method further includes automatically dating and storing a chat with the one or more LLMs in a chat history. In another aspect, the chat history is searchable or accessible by a third autonomous AI agent. In another aspect, the method further includes a fourth autonomous AI agent including a project manager AI agent, a lawyer drafting AI agent, a research assistant AI agent, a legal analyst AI agent, a real-time monitoring AI agent, a jury selection AI agent, a data scoring AI agent, a prosecution/plaintiff lawyer AI agent, a defense lawyer AI agent, a judge AI agent, a case development AI agent, a deposition, trial or appeal simulation AI agent, a mock trial game theory AI agent for strategy development and training purposes, an AI agent representing any other member or expert of any aspect of a case, a dynamically added AI agent, or a risk assessment AI agent. In another aspect, the method further includes configuring the fourth autonomous AI agent to operate a workflow stage including information gathering, claim evaluation, formal legal proceedings, formal case inventory initiation, formal discovery, case evaluation, depositions, hearings, trial preparation, trial, or appeal.

In another aspect, the one or more servers include an application server having a one or more first application programming interfaces (APIs), and an automation server having one or more second APIs. In another aspect, the first APIs include a category-based API, a LLM chat API, a file cabinet API, a notes management API, a user management API, or an audit and logging API. In another aspect, the second APIs include a continuous integrations and continuous delivery API, a workflow management API, a scheduler and batch processing API, an orchestration API, an automation API, or a data pipeline API. In another aspect, the one or more databases include an online transaction processing database communicably coupled to the one or more servers, a vector database communicably coupled to the one or more servers, a file or object storage platform communicably coupled to the one or more servers, and a graph database communicably coupled to the one or more servers. In another aspect, the user interface includes a web interface, a mobile interface, or a desktop interface. In another aspect, the method further includes providing a microphone communicably coupled to the one or more servers or the user interface, a camera communicably coupled to the one or more servers or the user interface, or a document scanner communicably coupled to the one or more servers or the user interface. In another aspect, the one or more LLMs are internally hosted or externally secure.

Various non-examples of using the system and method for the legal field will now be described. For example, an end-to-end legal case management, risk management, trial/business assistant workflow system uses modern generative and traditional AI to automate and enhance the development and management processes of a claim or lawsuit from inception of suit until trial, including evidence collection, witness and issue understanding, overall case understanding, game theory analysis of trial simulation, deposition creation, and real-time trial assistance. The system leverages advanced AI techniques and AI agents to significantly reduce the time required for each stage of case preparation to rial as well as improving the quality of legal work. The system also incorporates real-time assistance during trials, offering unparalleled support by providing advice, detecting inconsistencies in testimonies, and suggesting relevant case law, thereby increasing the likelihood of winning lawsuits. The system also automates an enhance risk management efforts that proactively identify pre-determined risk levels on a proactive basis and provide reports to management on a predetermined/configurable time basis. In addition, the system in real-time monitors (listens to) ongoing communications in a deposition, trial, arbitration, or any business meeting and identify any inconsistent prior testimony or communications, or any inconsistent email or documentation relevant to the ongoing communications.

Some functions of various embodiments of the present disclosure include the following.

Case/Matter Initiation: A user initiates a case in the system by uploading a dataset associated with the case or matter.

Evidence Analysis and Classification: If the user understands some of the people, facts or issues involved, the user can inform the system and the system will automatically classify the documentation/evidence and perform a comprehensive analysis to prepare an initial draft which identifies key facts, key documents, key individuals, and key issues. As noted above, such identification would include the Reference Docs relied upon by the AI in making such determination so that the user could verify the accuracy of the Al's determination.

Strategic Development: AI agents utilize game theory to simulate case scenarios, assisting in the formulation of legal strategies.

Interaction and Querying: Users interact with the system through a chat interface, querying the knowledge base and refining case strategies based on AI-generated insights.

Real-Time Assistance and Monitoring: During trial proceedings, the system provides real-time assistance, including lie detection, advice, and case law suggestions.

The system and methods described herein offer significant advantages over traditional legal, business, and risk management methods, including without limitation:

Time Efficiency: Potential to reduce the time required for case preparation and trial management by more than 50%. As example, what might take an associate a full day of work to accomplish (“Bring me every document relating to issue X, or person Y) can literally be accomplished in less than 10 seconds by the AI. Since many lawyers bill on an hourly basis, decreasing the amount of time needed by the lawyer should result in a significant decrease in fees billed to her client.

Quality/Effectiveness Improvement: Enhances the quality of legal work with AI assistance, leading to more rapid and better decision-making and strategy development (i.e. what is the value of having something with perfect knowledge and perfect/rapid recall advising you during the case).

Real-Time Support: Provides unparalleled real-time assistance during trials, increasing the likelihood of success in litigation.

Accessibility and Flexibility: Local, on-premises, or Cloud-based architecture ensures accessibility across devices, facilitating collaboration and mobility.

Decreased Risk: The risk management aspect of the system allows for immediate notification to the proper risk manager and ensures that the risk manager has the maximum amount of time possible to implement risk mitigation procedures.

Overall Economic Health: The 2023 American Corporate Counsel Management Benchmarking Report estimates that in 2023 over $80 billion were spent on legal. The American Bar Association estimates that $42.1 billion was spent simply on document review. By dramatically reducing the time spent on document review (as well as case development), the potential savings to businesses could be in the billions, and would allow businesses to reinvest such monies for job-producing activities or even additional charitable support.

Quicker Dispute Resolution: In addition to the financial savings, the system will allow cases to be more rapidly developed and, therefore, more rapidly resolved. This will help reduce the strain on courts and the communities whose tax dollars go to support the courts. In addition, it is axiomatic that lawsuits are stressful to both the litigants and the lawyers. More timely resolution will help reduce the length that a litigant will be under such stress.

The AI Legal Assistant System in accordance with one embodiment of the present disclosure is a comprehensive solution that automates the end-to-end workflow of risk management, legal case management, and trial preparation and execution. Key features of the system include:

Automated Evidence Collection and Analysis: The system ingests various types of evidentiary documents (emails, PDFs, DOCX files, spreadsheets, images, audio, and video files, etc.) and performs AI-based classification and analysis, enabling efficient evidence management and discovery.

AI-Powered Document and Individual Classification: The system allows for the classification of documents and individuals involved in a case, facilitating the identification of privileged information, relevant parties, issue identification, relationships between issues and/or people, and connections between individuals based on communication analysis.

Advanced AI Techniques For Rapid Discovery and Case Development: Incorporating retrieval augmented generation (RAG), knowledge graphs, and multiple AI agents, the system provides varied approaches to document retrieval, legal reasoning, and argument formulation.

Interactive Querying and Analysis with Generative AI: Through a chat or voice interface, users can interact with the system using natural language to ask questions and retrieve information about the case, significantly accelerating case strategy development.

Game Theory AI Agent Interactions for Simulated Case Development and Trial: AI agents simulate arguments for and against the case, providing a predicted outcome based on the evidence and legal understanding, enhancing strategy development. The system can produce simulated courtroom scenarios with AI-generated lawyers for training and strategy refinement purposes.

Real-Time Risk Management: The system monitors and ingests source references (e.g. contract, project plans, project communications, or anything compliance assessment and risk is desired to monitor), with respect to all collectable information (documents, emails, plans, meetings etc.) to real-time assess, monitor, alert, and provide recommendations to risk managers to allow them to timely implement risk management strategies.

Real-time Trial Assistance: Utilizing real-time processing of documents, emails, conversations, meetings, prior testimony and courtroom proceedings, the system proactively offers instantaneous advice to business and legal professionals relative to any statement or issue, detects and identifies discrepancies with prior testimonies/communications/documentation, proactively suggests lines or response or additional inquiry, and identifies case law, statutes, regulations, etc. that are relevant to the ongoing communications.

The AI Legal Assistant System is versatile and can be deployed on-premises or on the cloud-based platform, ensuring accessibility across desktop and mobile devices. The system architecture comprises several key components:

Data Ingestion Module (Matters, Files upload, issues & people): Supports the intake of a massive amount of diverse document types and real-time courtroom or business audio or video feeds.

Integrating new documents into the system is done in a highly parallel scalable way utilizing multi-processor and scalable parallel processing techniques.

AI Analysis Engine: Includes multiple LLMs and AI configurable agents specialized in document analysis, legal case analysis, evidence interrogation, and real-time courtroom assistance.

User Interaction Interface (AI chat with matters): A chat/voice-based interface allows users to interact with the system in natural language, posing questions and receiving answers that include references and summaries.

Near instant retrieval and answering of key questions.

One technical approach towards achieving the above is with a retrieval augmented generation (RAG), and/or knowledge graph.

Use of multiple LLM's (internally hosted or externally secure) and AI agents. The user can configure multiple AI agents, each which a different approach to responding to a question or statement, and to reason and provide answer variations over the responses (e.g. not exhaustive).

AI agents may have different ways to find relevant portions (chunks) of documents (e.g. top K similarity, tree summary of key docs, fusion, hyde rag, sentence window, etc.).

Some AI agents may look for relevant legal cases for a given question.

Some AI agents may look for relevant public information to a given question (e.g. What was the impact of the hurricane on the construction of hotel ABC by company X in location Y?).

Some AI agents may monitor electronic communications and provide real-time updates relative to predetermined/configurable levels of risk.

Recursive answer generation, which uses the answers from multiple AI agents to encourage the other AI agents to produce better summary answers.

Smart in-depth retrievers which look for answers to a question by progressively moving down the chunks in a highest to lowest similarity fashion.

All answers check for hallucination and grounding to ensure the answers produced are grounded by the documents.

A chat/voice interface allows interacting with documents in Question/Answer mode

Each AI agent's will provide a summarized answer to an inquiry. Then, each AI agent will identify the specific reference documents/sources it utilized in responding.

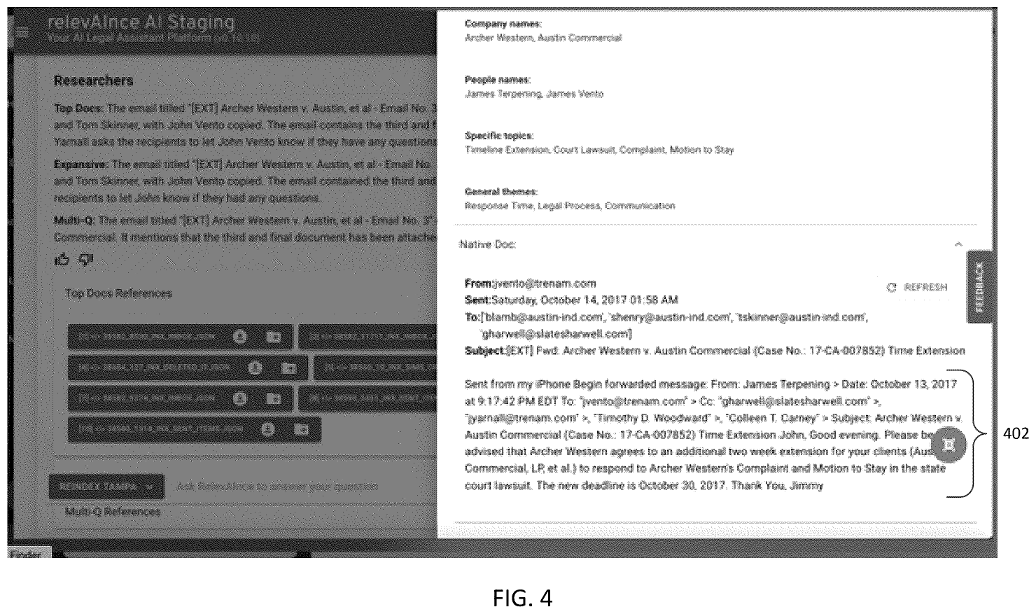

Using GenAI to “AutoFormat Documents that are jumbled to the user”. As shown in FIG. 4, sometimes documents are jumbled in their native format (e.g. emails) and are hard to read for the user. (see e.g., where the body of the document runs all together 402).

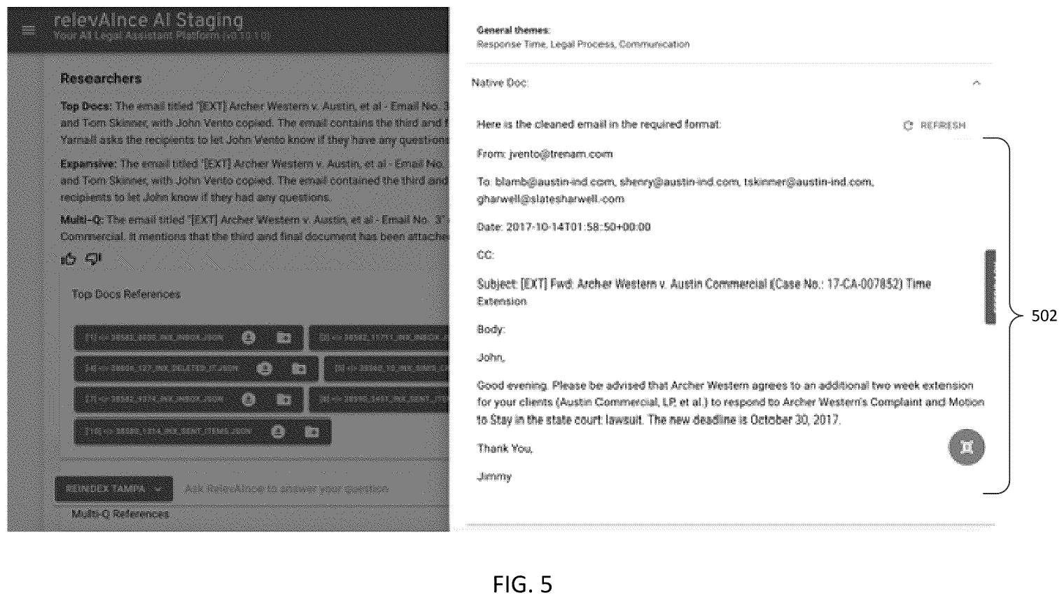

Using the “Refresh” command, the tool sends the document to our “auto reformatter LLM” which cleans up the email 502 to make it presentable to the user, which is a great user experience saver as shown in FIG. 5.

Each reference document/source (“Reference Doc”) can be selected for review (“trust but verify”). When a Reference Doc is selected, a separate screen appears that includes (i) a short summary of that Reference Doc's content, an identification of the people, organizations and issues associated with that Reference Doc, and the “full text” document with the portions of the document relied upon by the AI to respond being automatically highlighted.

In the original summarized answer, the summary of the Reference Doc, or the full text document itself, on can manually highlight some portion of the text and the AI will automatically conduct a separate inquiry based on the highlighted text, allowing you to drill down on just the information that is most relevant to the user's inquiry.

A flexible chat interface that can also specifically “chat within the File Cabinet” (see below) with any documents, information or Notes (see below) that the user has previously filed in the file cabinet, again allow an even more focused inquiry.

Every chat is logged into a chat history that is automatically dated or can be manually named, so that retrieved for additional inquiry in the future. All chat histories can be filed in a specific folder in the File Cabinet, but all histories are also automatically maintained in a searchable location of its own.

Within any text highlighted on the page, the user will have the ability to edit, or send the highlighted information to the AI agents to find similar documents to ensure no relevant document is missed.

At any screen or page on the platform, one can separately create a “post-it” Note, and append such Note on any document and/or file such Note in the File Cabinet to allow for efficiency in review at some later date.

Auto-Summarizer: For a large case, there could be 10's or 100's of Terabytes of files. It is next to impossible for any person to learn and understand this information, all of the people or issues, of the associations between this information or people in a timely, efficient and effective manner to allow for quicker learning. To solve this problem, the system produces a custom summary as follows: After collecting the documents, the system auto-generates a summary of key concepts and timelines about the case. One way of doing this is as follows:
(a) Collect all documents and embed into chunks into a vector store.
(b) Perform clustering (e.g., using ranked similarity scores or a K-means for K clusters) of the embedding space.
(c) Extract M chunks of text for each of the K clusters and summarize these chunks with an LLM into K Summaries.
(d) Summarize the K Summaries for the case.

Steps (b)-(d) steps can be learned and optimized over time as the system analyzes what humans do.

A second approach may be to create “triplets” of relationships of chunks of the document so that the produced triplets produce a large knowledge graph representation of the document. As such, there will be clusters of the graph which then can be fed into an LLM to create summaries of each cluster. Afterwards a summary of summaries can be produced to describe the document.

Classification and Tagging System: Facilitates the tagging of documents and individuals with standard and custom classifications, enabling efficient management and retrieval of case-relevant information.

System includes basic search.

Can be used to label all search results found.

Standard classifications per document:

Privileged/Not privileged.

Involves person ABC.

Involves company ABC.

Is related to issue XYZ (e.g. is this a legal issue), scored via a variety of similarity scores (e.g. BERT, cosine, etc.).

Graph analysis of all conversations or interactions (direct or indirect) to allow (examples).

Most connected person (centrality measures).

Persons most “between” others (betweenness measures).

Persons close to each other (closeness measures).

Auto-identifies people of interest in regards to a case (given company A, company B, and issues N1,N2, . . . ,NZ) auto-identify all the relevant people.

Custom classifications per document (examples).

Is Relevant to Issue XYZ.

Autonomous AI agents for Recommendations and Narrative Updates: In addition to the chat interface, where the system is “trained via retrieval augmented generation, and separate autonomous AI agents construct are enabled”. AI agents in this case, denote software automation services that are guided by language prompts for their goal (output requested), which LLMs they have access to, what tools they can use to retrieve information, and who they are to communicate the results to. These AI agents can be configured to assist an any part of a workflow in the following manner:

An AI agent is defined and given a backstory and a goal which is fed to a LLM as a prompt.

The AI agent then uses the LLM and the backstory prompt and goal prompt, as well as any tools (e.g. things they can do such as search the web, connect with others to receive input, query an internal document database, etc.) that will be useful to accomplish the goal.

At any point in the workflow, the AI agent can be configured to use other AI agents to accomplish tasks or get input and the can be configured to share status with a human(s), where they can receive clarifying instructions.

For instance, in the legal use case, the workflow for a case, or matter along with how the AI agents are trained, and used to produce outputs is shown in the table below.

| | AI agents | Backstory | | |
|---|---|---|---|---|
| | involved, | (prompts are given to | Tools (how they are | |
| Workflow | communication | the LLM) | trained to answer | |
| Stage | path | Goals: | questions) | Outputs |
| 1. Initial | AI Agent 1 - | AI Agent 1- You are a | Documents: | Initial strategy |
| information | Project | senior lawyer that is an | Can retrieve the claim | document |
| gathering, | Manager | expert on reviewing | documents, and a list of | containing |
| claim | | claims, developing a set | people. (the assumption | (summary of the |
| evaluation | | of initial questions, can | is that these are | answers to the |
| | | determine who to | relatively small and can | questions, by |
| | | collect informal | fit into prompt, so that | whom). |
| | | information from, and | RAG is not needed) | Strategy outline of |
| | | can develop strategy. | Email/Teams chat | next steps. |
| | | AI agent 1 (Goals): | interface. | This output is given |
| | | 1. List of questions; | | to a guiding human |
| | | 2. List of people to | | or set of humans for |
| | | answer the questions; | | review. |
| | | 3. Initial strategy | | |
| | | document. | | |
| 2. Formal | AI Agent1 - | AI Agent 1 | Tools: | Draft formal |
| proceedings | Lawyer | (backstory/goal): You | Strategy document from | proceedings. |
| | drafting AI | are an expert legal | 1. Example previous | |
| | agent | attorney. You are to take | formal proceedings of | |
| | | the strategy document, | similar use cases. | |
| | | as well as previous | | |
| | | examples, and any input | | |
| | | from the guiding | | |
| | | humans and produce a | | |
| | | draft lawsuit for review. | | |
| 3. Formal | AI Agent 1 - | AI agent 1 | Tools: | List of documents |
| case | Lawyer | (backstory/goal): You | RAG tool to query | that are relevant to |
| inventory | drafting AI | are an expert legal | internal documents. | defendant side |
| initiated | agent | attorney that specializes | | needed |
| | | in drafting requests for | | |
| | | documents in lawsuits | | |
| 4. Formal | AI Agent 1 - | AI agent 1 | Tools: | List of documents |
| discovery | Lawyer | (backstory/goal): You | RAG tool to query | that are relevant to |
| | drafting AI | are an expert legal | internal documents. | defendant side that |
| | agent | attorney that specializes | Drafting examples and | will be shared, and |
| | | in drafting requests for | formats typically used | list of documents |
| | | documents in lawsuits | to exchange documents. | that will be shared |
| | | | | from prosecuting |
| | | | | side. |
| 5. Case | AI agent 1 - | AI Agent 1 (backstory): | Tools: | Output: |
| evaluation | Layer project | You are an expert legal | AI Agent 1: RAG tool to | 1. Narrative of the |
| | manager, | project manager, you | query all documents, list | case, and pros and |
| | AI agent 2 - | have two other AI | of other AI agents at | cons. |
| | Research | agents that can do work | disposal to execute | 2. References used. |
| | assistant, | for you. Please assign | tasks. | |
| | AI agent 3 - | the AI agents below a | | |
| | Legal reviewer | task and pass on the | | |
| | expert | backstory (This | | |
| | | case/matter involves | AI Agent 2: RAG to | |
| | | XYZ, with the | search all documents | |
| | | following prosecuting | and collect relevant | |
| | | and defending parties. | people, issues that could | |
| | | You work for the | be used for the case. | |
| | | defendant, and your | AI Agent 3: Web tool to | |
| | | goal is to produce a full | do searches for case | |
| | | narrative of the case, | law. | |
| | | after consulting with | | |
| | | your legal research | | |
| | | assistant legal analyst | | |
| | | AI agents. | | |
| | | AI Agent 2: Legal | | |
| | | assistant researcher. | | |
| | | You are to research all | | |
| | | aspects of this matter | | |
| | | with respect to the goal. | | |
| | | AI Agent 3: Legal | | |
| | | analyst. You are an | | |
| | | expert legal analyst and | | |
| | | your goal is to assess | | |
| | | any research provided | | |
| | | vs. the law as it pertains | | |
| | | to this case. | | |
| 6. Deposition | | | | |
| 7. Hearings | AI Agent 1 - | AI agent 1 (backstory): | Tools: | Output: Scores per |
| | Lawyer project | You are an expert legal | All | candidate juror |
| | manager, | project manager, you | AI agents: | (cj_x): |
| | AI Agent 2 - | have two other AI | Backstory of the | cj_1: 0.73 |
| | Jury selection, | agents that can do work | case/matter | cj_2: 0.43 |
| | data collection | for you. Please assign | AI agent 2: web | cj_3: 0.13 |
| | AI Agent 3 - | the AI agents below a | extraction tool for | . |
| | Data scientist, | task and pass on the | Social media, any | . |
| | uses data | backstory (This | online content and | . |
| | collected from | case/matter involves | records per potential | cj_n: 0.94 |
| | AI agent to | XYZ, with the | juror | |
| | score all jurors. | following prosecuting | AI agent 3: Previous | |
| | | and defending parties. | models scored, and the | |
| | | You work for the | ability to inference | |
| | | defendant, and your | (score) each juror. | |
| | | goal is to produce a full | | |
| | | narrative of the case, | | |
| | | after consulting with | | |
| | | your legal research | | |
| | | assistant legal analyst | | |
| | | AI agents. | | |
| | | AI Agent 2: Expert Jury | | |
| | | Selection data | | |
| | | collection AI agent. | | |
| | | You are an expert jury | | |
| | | selection AI agent who | | |
| | | has access to tools to | | |
| | | collect Jury background | | |
| | | documents for each | | |
| | | juror. You are to | | |
| | | automatically extract | | |
| | | the answers to the | | |
| | | following N questions | | |
| | | 1) Has this person | | |
| | | posted or comment on | | |
| | | content that is XYZ | | |
| | | (e.g. XYZ determined | | |
| | | by the case/matter)? 2) | | |
| | | does this person have a | | |
| | | college degree? 3) does | | |
| | | this person own a | | |
| | | business? 4) is this | | |
| | | person employed? 5) is | | |
| | | this person wealthy? 6) | | |
| | | is this person ABC? 7) | | |
| | | The age of the juror is | | |
| | | young? 8) the age of the | | |
| | | juror is mid age, 9) the | | |
| | | age of the juror is old. | | |
| | | etc. | | |
| | | AI agent 3: Data | | |
| | | Scientist. You are an | | |
| | | expert data scientist that | | |
| | | has access to previously | | |
| | | scored models | | |
| | | according to a set of | | |
| | | standard questions. You | | |
| | | are to build a predictive | | |
| | | model that predicts | | |
| | | whether the juror will be | | |
| | | for or against the | | |
| | | defendant in this matter. | | |
| | | The model should score | | |
| | | a number per juror | | |
| | | between 0 and 1, where | | |
| | | 1 is definitely for the | | |
| | | defendant and 0 is | | |
| | | definitely not for the | | |
| | | defendant. | | |
| | | Note: This is along the | | |
| | | lines of | | |
| | | www.infotrack.com/blog/ | | |
| | | ai-jury- | | |
| | | selection/#:~:text=Using | | |
| | | %20different%20forms | | |
| | | %20of%20AI, favorability | | |
| | | %20as%20a%20potential | | |
| | | %20juror. | | |
| | | However it has AI | | |
| | | agents to automatically | | |
| | | collect the data per | | |
| | | juror, it doesn't rely | | |
| | | only one some canned | | |
| | | attributes, but many | | |
| | | attributes previous | | |
| | | models scored so that it | | |
| | | can glean information | | |
| | | automatically and score | | |
| | | the juror. | | |
| 8. Trial prep | | | | |
| 9. Trial | | | | |
| 10. Appeal | | | | |

Autonomous AI agents will constantly be updating any/all aspects of the case such as: best narrative for defending/opposing parties, and suggested witnesses and associated deposition/questions.

Game Theory AI Agent Interactions for Simulated Case Development and Trial: Utilizing the information provided in the relevant dataset, AI agents can simulate arguments for and against the case, an issue in the case, or a legal position in the case, providing a predicted outcome based on the evidence and legal understanding, thereby enhancing strategy development. The system can produce simulated courtroom scenarios with AI-generated lawyers for training and strategy refinement purposes.

AI agents create probing questions, get answers and formulate legal arguments and place all their findings in a file cabinet. AI agents file relevant questions/answers into file cabinets (such as), Auto-file cabinet creation.

### Key Witnesses

AI agents produce proposed depositions based on the understanding of the case, by their formulation of questions, and answers in their interaction with the knowledge store.

### Key Documents

Both AI agents work together with human agents and all agents can have their own persona.

AI agents “learn” from lawyers using the system and how they formulate their analysis and arguments for a given case, such that when the next case is submitted, they follow the same reasoning and logic and auto-prepare the case for review.

This may be used as example for creating the initial case summaries.

The AI legal assistant does this by keeping track of all questions, answers, and things stored in the file cabinet.

System ability to automatically analyze historical cases to test/improve it's own ability predict outcomes. Full Game theory (AI continuously playing both sides of case) for discovery of strategy and potential non-obvious legal aspects/angles.

AI playing/learning from old case history? Actual measurements of accuracy predictions.

Auto Highlight and auto-compose key points of relevance (ability to regenerate upon demand as new aspects (case law or trial points) are revealed.

For every case scenario, AI agents are formed to argue for and against the case given a certain set of evidence provided and case law understood. The system produces a predicted outcome given the arguments and evidence.

AI agents “play against each other” (possibly with human input) using different arguments, case law etc. and the system estimates the predicted outcome to come up with the best approaches

The system has the ability to produce a video of simulated lawyers providing arguments for and against in a mock trial or any aspect of the case development workflow.

### Smart File Cabinet

The ability to retrieve information, summaries, thoughts, etc. developed by the user over the extended lifetime of a case or project, the user has the option to design, modify and utilize a configurable smart File Cabinet. At any location in the system, chat, interaction, queries, Notes, comments, etc., the user is able store this information into one or more configurable folders in the smart File Cabinet.

The user may instruct the AI to select, search, chat, and generate content using only information within in the File Cabinet, or information inside the File Cabinet and the overall dataset being utilized.

Ultimately, the File Cabinet will contain most, if not all, of the information, documents, thoughts or ideas that will be utilized to try the case or implement project strategies.

Generation of Documents: Once the documents are collected/ingested and people and issues identified, and especially after the user has sufficiently populated the applicable folders in the File Cabinet with focused information or Notes, separate documents can be generated (e.g. which could be implemented as a push-button which generates a prompt to provide the AI agents) to, without limitation:

Create a draft outline of inquiry (questions) to be utilized in deposition or trial witness examination.

Prepare an initial draft of discovery (interrogatories, requests for production, requests for admissions) focused solely on the people and issues involved.

Prepare an initial draft of a motion or other pleading to be filed with a court.

Prepare an initial draft of materials that could be used as a foundation for further legal research.

Prepare initial drafts of any number of business-related documents (contracts, NDA's, employment agreements, etc.), summaries, etc.

Any draft of any legal document is simply a draft. Every user must have the draft independently reviewed and approved or modified by licensed legal counsel (another “trust but verify” strategy).

Real Time Monitoring/Reporting/Advising: Risk Management. As noted throughout this document, the system can monitor (in real time) all electronic communications or data across multiple projects and locations. Utilizing a predetermined/configurable “risk level score” and identification system (e.g. Green/Yellow/Red), the system will (i) report the current level of risk associated with each project/location (e.g. Green/Yellow/Red), (ii) provide status updates to the appropriate risk manager, (iii) promptly notify a risk manager of any change in a risk status (e.g., go from Green to Yellow), (iv) identify the documentation/information relied upon in make the risk status change, and (v) suggested potential risk mitigation strategies.,

The system monitors and ingests source references (e.g. contract, project plans, project communications, or anything compliance assessment and risk is desired to monitor), with respect to all collectable information (documents, emails, plans, meetings, voice streams etc.) to real-time assess, monitor, alert, and provide recommendations for mitigations (see FIG. 2). For example, contract, corporate or governmental compliance issues, potential breach of contract scenarios, pending deadlines, performance of the project relative to previous baseline projections (e.g. budgetary, schedule, etc.).

Configurable and auto-determined risk levels: The system allows both configurable risk levels based on data levels, or concepts, as well as AI auto-determined risk.

AI Risk reasoning and notification: All risks assessed are provided with references and reasoning for how the risks have changed over time. For example, if the risk went from “green to yellow” it pro-actively notifies recipients (configurable) with the reason for the change, and attaches the specific documents used in the reasoning.

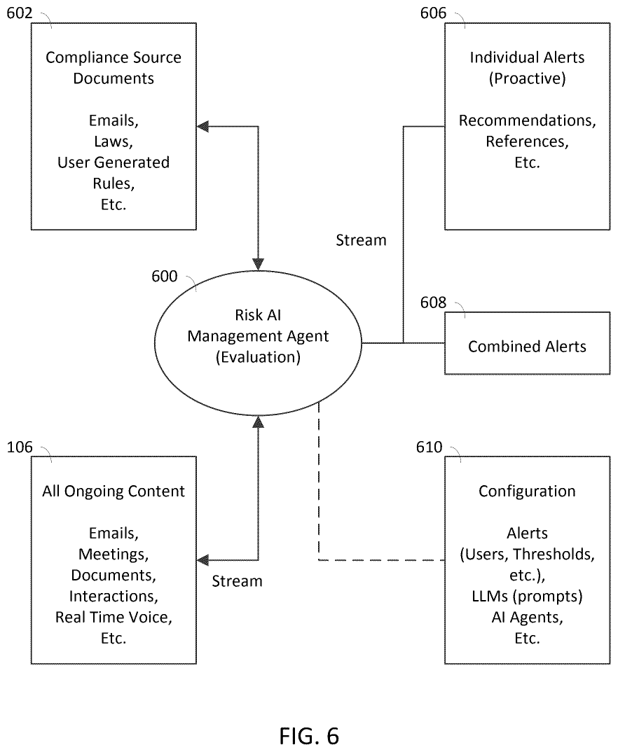

Now referring to FIG. 6, a block diagram of a risk management AI agent 600 is shown in accordance with one embodiment of the present disclosure. The risk management AI agent 600 receives data from source documents 602 (e.g., contracts, laws, user generated content, etc.) and all ongoing content 602 (e.g., emails, meetings, documents, interactions, real time voice, etc.). The risk management AI agent 600 analyzes the source documents 602 and ongoing content 604 and identifies individual alerts 606 or combination alerts 608. The alerts 606 and 608 may include recommendations and references. In addition, risk management AI agent 600 can be configured 610 for alerting uses and thresholds, LLM prompts, AI agents, and other criteria.

### Real Time Monitoring/Reporting/Advising: Lawsuits and Meetings

For lawsuits: Subject to approval of the court, once the dataset is ingested by the system, the system can both listen and watch (with microphones/cameras) to every word, sentence, train of thought, faces (when permitted), throughout the case of the witnesses, judge, lawyers, and all media outside the courtroom and dynamically process all such inputs to:

Identify all participants speaking: The system is able to understand who is speaking and classifying it to a given witness, counsel, judge etc.

Technically this can be done in a variety of ways

Manual labeling: by having the system “listen” to the person speaking and then having “the operator of the system” label the person speaking.

Auto-labeling with audio assist: The system, listens to the person speaking, does speech to text, and then compares the text spoken vs. all collected evidence (e.g. via Retrieval Augmented Generation from the), as well as listening for words such as “I”, or “You” to identify whether it is a witness, lawyer (prosecuting or defendant), judge, or otherwise.

Auto-labeling with video assist: When a camera is deployed, the AI legal assistant will compare the layout of the courtroom, and stored pictures to determine who is speaking for a given portion.

Real-time Inconsistency Detection: Inconsistency detection is done in a variety of ways:

By comparing all statements of a given person vs. all content in the initial dataset, as well as all other content collected over the course of case. Through this comparison, the AI can detect and identify statements that are not consistent or true.

This can be done in a variety of ways, one of which is using a retrieval augmented generation (RAG) system as follows:

A sliding window of speech transcript is collected An LLM formulates the speech in the sliding window into a set of questions

Retrieval augmented generation compares the questions generated against the knowledge store (e.g. from a vector store or knowledge graph) by extracting similar text and then reasoning over the extracted text with an LLM to determine the similarity of the statement.

If the LLM determines the statement is not similar to the content from the knowledge store a “lie indicator is provided”. Note: this can be a tuned (fine tuned RAG) LLM which has other advantages such as low latency and potentially accuracy. Tuning can be done on both the documents and the user's interaction with the documents.

Another approach besides using RAG is to simply use an LLM that has been specifically trained on all relevant documents, so that any sliding window can be sent directly to the trained LLM to confirm or deny its correctness. (Note: in this case, LLM's themselves can even be replaced by simple transformers that can be trained on a given question and answer to check for validity).

Another approach is to utilize the camera to detect or supplement the audio with behavioral cues which may indicate falsehood.

Once an inconsistency or falsehood is identified, the AI system can immediately notify the user of the bases of the Al's conclusion (e.g. identifying prior inconsistent testimony, identifying documentation that is inconsistent with the statement, etc.) The lawyer can immediately put this information onto the courtroom screen to impeach and discredit the witness.

Real-time sentiment analysis: Using similar methods as in the lie detection, but tuned to understand sentiment by scoring the following: detecting strong language, vocabulary changes, grammar, stuttering/speech patterns; volume; tone; and body language (e.g. from camera), micro-expressions.

Relevant law/rulings for any portion or total context: Similar to the ability of the system to detect lies or differences in statements made vs. content in the knowledge store (from evidence of emails, statements, depositions), the AI legal assistant platform can also dynamically recommend relevant law, cases, and arguments for the case.

This can be done using the same RAG system above, albeit by looking up relevant case law or legal content in the knowledge store.

Relevant detection of “new information” either from during the case trial, or via sensing external sources (such as the internet).

The AI Risk Management and Legal Assistant System represents a significant advancement in legal, business and risk management technology, offering an end-to-end solution for automating risk (both legal and business), case development and management, deposition and trial preparation, and any business meeting. Through its innovative features and use of advanced AI, the system addresses the challenges of traditional risk avoidance, legal processes, business conduct by providing efficiency, accuracy, and strategic advantage to both business and legal professionals.

It is understood that particular embodiments described herein are shown by way of illustration and not as limitations of the invention. The principal features of this invention can be employed in various embodiments without departing from the scope of the invention. Those skilled in the art will recognize or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited features, elements, components, groups, integers, and/or steps, but do not exclude the presence of other unstated features, elements, components, groups, integers and/or steps. In embodiments of any of the compositions and methods provided herein, “comprising” may be replaced with “consisting essentially of” or “consisting of”. As used herein, the term “consisting” is used to indicate the presence of the recited integer (e.g., a feature, an element, a characteristic, a property, a method/process step or a limitation) or group of integers (e.g., feature(s), element(s), characteristic(s), property(ies), method/process steps or limitation(s)) only. As used herein, the phrase “consisting essentially of” requires the specified features, elements, components, groups, integers, and/or steps, but do not exclude the presence of other unstated features, elements, components, groups, integers and/or steps as well as those that do not materially affect the basic and novel characteristic(s) and/or function of the claimed invention.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

To aid the Patent Office, and any readers of any patent issued on this application in interpreting the claims appended hereto, applicants wish to note that they do not intend any of the appended claims to invoke paragraph 6 of 35 U.S.C. § 112, U.S.C. § 112 paragraph (f), or equivalent, as it exists on the date of filing hereof unless the words “means for” or “step for” are explicitly used in the particular claim.

For each of the claims, each dependent claim can depend both from the independent claim and from each of the prior dependent claims for each and every claim so long as the prior claim provides a proper antecedent basis for a claim term or element.

1. A system comprising:
an application server having one or more first application programming interfaces (APIs);
a user interface communicably coupled to the application server with one of the first APIs;
an automation server having one or more second APIs;
an online transaction processing database communicably coupled to the application server with one of the first APIs, and the automation server with one of the second APIs;
one or more large language models (LLMs) communicably coupled to the application server with one of the first APIs, and the automation server with one of the second APIs;
a vector database communicably coupled to the application server with one of the first APIs, and the automation server with one of the second APIs;
a file or object storage platform communicably coupled to the application server with one of the first APIs, and the automation server with one of the second APIs; and
a graph database communicably coupled to the application server with one of the first APIs, and the automation server with one of the second APIs.

2. The system of claim 1, wherein the first APIs comprise:
a category-based API;
a LLM chat API;
a file cabinet API;
a notes management API;
a user management API; and
an audit and logging API.

3. The system of claim 1, wherein the second APIs comprise:
a continuous integrations and continuous delivery API;
a workflow management API;
a scheduler and batch processing API;
an orchestration API;
an automation API; or
a data pipeline API.

4. The system of claim 1, wherein the user interface comprises:
a web interface;
a mobile interface; or
a desktop interface.

5. The system of claim 1, further comprising:
a microphone communicably coupled to the application server with one of the first APIs or the user interface;
a camera communicably coupled to the application server with one of the first APIs or the user interface; or
a document scanner communicably coupled to the application server with one of the first APIs or the user interface.

6. The system of claim 1, wherein the one or more LLMs are internally hosted or externally secure.

7. The system of claim 1, wherein files or objects within the file or object storage platform are automatically formatted.

8. The system of claim 1, wherein files or objects within the file or object storage platform are automatically summarized by:
embedding the files or objects into chunks in the vector database;
clustering the chunks using ranked similarity scores or a K-means for K clusters;
extracting M chunks of text for each of the K clusters; and
summarizing the M chunks with one of the LLMs into summaries for the files or objects.

9. The system of claim 8, wherein the LLM learns and optimizes the embedding, clustering, extracting and summarizing steps over time.

10. The system of claim 1, wherein files or objects within the file or object storage platform are automatically classified using one or more identifiers.

11. The system of claim 10, wherein the one or more identifiers comprise:
a file or object type;
a legal classification;
a person related to or mentioned in the file or object;
an entity related to or mentioned in the file or object; or
an issue related or mentioned in the file or object.

12. The system of claim 1, wherein a graph analysis is performed on the files or objects within the file or object storage platform.

13. The system of claim 1, further comprising an AI generative document creator communicably coupled to the application server.

14. The system of claim 1, further comprising one or more autonomous AI agents communicably coupled to the one or more LLMs.

15. The system of claim 14, wherein each autonomous AI agent has a configuration comprising:
a backstory;
one or more goals;
a model selected from the one or more LLMs;
one or more training tools; and
a required output.

16. The system of claim 15, wherein the required output includes one or more citations to a supporting file or object.

17. The system of claim 16, wherein a summary of the supporting file or object, an identification of people, organizations and issues within the supporting file or object, and a full text of the supporting file or object with one or more highlighted portions relied upon by the autonomous AI agent are provided.

18. The system of claim 15, wherein the one or more training tools comprise:
files or objects within all or part of the file or object storage platform;
specified files or objects;
a chat interface;
one or more retrieval-augmented generation tools;
one or more knowledge graphs;
a web searching tool; or other autonomous AI agents.

19. The system as recited in claim 18, wherein each chat via the chat interface is automatically dated and stored in a chat history.

20. The system as recited in claim 19, wherein the chat history is searchable or accessible by other autonomous AI agents or the user interface.

21. The system of claim 14, wherein the one or more autonomous AI agents comprise:
a project manager AI agent;
a lawyer drafting AI agent;
a research assistant AI agent;
a legal analyst AI agent;
a real-time monitoring AI agent;
a jury selection AI agent;
a data scoring AI agent;
a prosecution/plaintiff lawyer AI agent;
a defense lawyer AI agent;
a judge AI agent;
a case development AI agent;
a deposition, trial or appeal simulation AI agent;
a mock trial game theory AI agent for strategy development and training purposes;
an AI agent representing any other member or expert of any aspect of a case;
a dynamically added AI agent; or
a risk assessment AI agent.

22. The system of claim 14, wherein the one or more autonomous AI agents comprise a risk assessment AI agent, and the risk assessment AI agent:
monitors electronic communications and data across one or more projects and locations;
determines a risk level of each project and location based on the monitored electronic communications and data; and
reports the risk level using the user interface.

23. The system of claim 22, wherein the risk assessment AI agent:
provides a notification of any change in the risk level using the user interface; and
identifies any documentation or information relied upon to make the change in risk level.

24. The system of claim 23, wherein the risk assessment AI agent generates one or more risk mitigation strategies in response to the change in risk level.

25. The system of claim 14, wherein the one or more autonomous AI agents are configured to operate a workflow stage comprising:
information gathering;
claim evaluation;
formal legal proceedings;
formal case inventory initiation;
formal discovery;
case evaluation;
depositions;
hearings;
trial preparation;
trial; or
appeal.

26. The system of claim 14, wherein the one or more autonomous AI agents comprise a generative AI document creator that is configured to generate:
a draft outline of inquiry to be used in a deposition or a trial witness examination;
an initial draft of interrogatories, requests for production or requests for admissions;
an initial draft of a motion or other pleading to be filed with a court;
an initial draft of materials used as a foundation for further legal research; or an initial draft of a contract, agreement or other legal document.

27. The system of claim 14, wherein the one or more autonomous AI agents comprises a real-time monitoring AI agent and further comprising:
a microphone is communicably coupled to the real-time monitoring AI agent;
a camera is communicably coupled to the real-time monitoring AI agent; and
wherein the real-time monitoring AI agent is configured to:
receive audio data of one or more people from the microphone,
receive video data of the one or more people from the camera,
identify the one or more people based on the audio data, the video data, or a combination of the audio data and the video data,
identify a statement within the audio data or the video data, and
provide the statement to a user using the user interface.

28. The system of claim 27, wherein the real-time monitoring AI agent is further configured to:
access data relevant to the statement within the vector database, the file or object storage platform or the graph database; and
wherein the statement comprises an inconsistency or falsehood based on the accessed data or behavioral clues from the one or more people within the audio data or the video data, and the data accessed from the one or more databases.

29. The system of claim 27, wherein the statement comprises a sentiment of the one or more people based on behavioral clues within the audio data or the video data.

30. The system of claim 27, wherein the real-time monitoring AI agent is further configured to:
access data relevant to the statement within the vector database, the file or object storage platform or the graph database; and
wherein the statement comprises a relevant law, case or argument based on the audio data or the video data and the data accessed from the one or more databases.

31-63. (canceled)
